(19) United States
(12) Patent Application Publication
(10) Pub. No.: US 2002/0091568 A1
(43) Pub. Date: Jul. 11, 2002

(54) Personalized profile based advertising system and method with integration of physical location using GPS

(75) Inventors: Reiner Kraft, Gilroy, CA (US); Daniel A. Ford, Lost Gatos, CA (US); Kevin T. Cao, Hamburg (DE)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: International Business Machines Corporation

(21) Appl. No.: 09/757,901

(22) Filed: Jan. 10, 2001

(51) Int. Cl. G06F 17/60

(52) U.S. Cl. 705/14

(57) ABSTRACT

Global Positioning System (GPS), Personal Data Assistant (PDA), and wireless communications are combines in order to create a more personalized advertising experience. The invention creates and presents advertising content founded on individual user profiles integrated with the physical geographic location of a consumer. The invention solves the problem of advertising tailored so that it is appropriate to both the user and their current location by including a customer's profile and his/her current location into the advertising message. Also, the invention integrates location tracking, e.g. GPS technology, with a personal electronic calendaring system. Further, an advertising message is more personalized by using a relative address/directions that start from the current customer's location. This information could be provided in the form of driving directions, using the current physical position of the user as a start address.

### PARTIAL WAIVER OF COPYRIGHT

All of the material in this patent application is subject to copyright protection under the copyright laws of the United States and of other countries. As of the first effective filing date of the present application, this material is protected as unpublished material. However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### CROSS-REFERENCE TO RELATED APPLICATIONS

Not Applicable

### FIELD OF THE INVENTION

This invention relates to Internet Technology and E-Commerce and more particularly to an improved method and apparatus for providing advertising information to individuals.

### BACKGROUND OF THE INVENTION

Database systems store enormous amounts of information that can be accessed by users for identification and retrieval of valuable documents that contain data, text, audio and video information. A typical example of a network based client-server system (100) is shown in FIG. 1. Information processing units (101a to 101n) can be any of the following: personal computers (DOS, WINDOWS or Macintosh, Linux machines), workstations, a client, a dumb terminal, digital cellular phones, personal data assistant (PDA), portable computers, vehicular computer systems or equivalent. Hub processing units (102a to 102y) can be any of the following: a server, a master, a database controller or equivalent. Network (100) can be any of the following: a token ring network, a star network, a telecommunication switching network, a local area network (LAN), a wide area network (WAN), a corporate intranet, the Internet or equivalent. Information processing units (101a to 101n) are in communication with hub processing units (102a to 102y) via network (100). The sharing of data across network (100) is accomplished by computer search programs (103a to 103x) operating in conjunction with the hub processing units (102a to 102y). The search programs can be located on the hub processing units themselves or on another processing units that are not shown. In addition, a user employs a graphical user interface (GUI 104a to 104n) that permits him or her to submit search queries across network (100) to the hub processing units.

Upon reception of the search query, the hub processing units forward the request to the search programs (103a to 103x) for completion of the transaction. As is well known, search programs provide Boolean Operators (AND, OR NOT) to help build more sophisticated queries in order to narrow down the search result set. These Boolean Operators are used to provide the various permutations to the search programs (103a to 103x) which uses these to locate pertinent documents. Once in possession of the search query, the search programs compare the requested search parameters against documents stored in databases (105a to 105z). Finding words or phrases that compare favorably with the search query, the search programs return a list of relevant documents to the information processing units (101a to 101n) as well as library information such as type of document, location and highlighted words or phrases indicating the flags that caused the search program to retrieve the particular document. Finally, the search results are loaded into the graphical user interface (GUI 104a to 104n) for the user's review.

A typical network that uses the aforementioned hub processing architecture is the Internet. Because of the increased use of the Internet and the concomitant explosion of commercial transactions on it, advertising budgets are being allocated more and more to the exploitation of this newly emerging marketplace. Newly derived E-Commerce applications are gaining more and more popularity as advertising money is diverted from conventional media channels (e.g. TV, radio) into Internet based communication channels (banner ads, or the equivalent).

In an attempt to make the E-Advertising more palatable and pleasing to users ongoing efforts emphasize personalization as a new advertising model. The ultimate goal of this personalization is to engender traits and characteristics within a highly targeted advertising communication model thereby generating more successful sales. Typically, individuals enter personal data into questionnaires about their interests, background, tastes and habits. An advertising service compares this personal data to merchant data stored in a database and returns advertising information based upon the questionnaire entries.

Technology exists for conducting commercial activities such as an auction in a rather localized area such as a shopping mall. Potential consumers present in the local area have a mobile wireless communications device (for example, a smart cellular phone, a 2-way radio or a Bluetooth communication device) including a set of stored instructions allowing the device to be programmed with a set of desired transactions and preferences; these can include the brands or transaction types which a consumer prefers. Merchants are connected to receive an information stream from the communications device and respond to the desired transaction and preferences by proposing goods or services at specific terms such as price. The mobile wireless communications device associated with the potential consumer can receive communications from merchants, either directly or through an intermediate system, and can transmit a reply back to the merchant indicating a proposed offer so that a merchant can revise or improve the offer. In this way, local merchants can be aware of consumers' offers and can improve on those offers to secure consumers' business. While the actual transaction may be conducted in person at the merchant's location, one can envision a system where the transaction is completed through a wireless communications system; payment can occur through charge or some other electronic transaction and the delivery of the goods or services through conventional delivery channels.

Returning to the subject of E-advertising, it must be recognized that in order to secure attention, advertising has to be interesting to the potential customer otherwise it is simply ignored. Essentially, a transaction is likely to occur if the advertisement matches the current desire of a customer and communicates an efficient response to this desire. Consumer preferences are not static; on the contrary, they change continuously based upon the daily lives, interests, needs and dreams of consumers. E-advertising that does not include the changing personal situation of a customer is too general and therefore not effective in communicating advertisements to a user that might effect a purchase.

Further, one E-Advertising factor which has not been fully addressed is the location of a customer. For instance, if someone who didn't have the desire to buy an umbrella is walking around in a city when it suddenly starts to rain that person might want to purchase one. In addition, if someone is driving along a highway and passes a store that has some specials, it might be convenient to take advantage of these. Therefore, today's E-advertising approaches that do not integrate the current location and preferences of customers need to incorporate some solutions to these deficiencies into their methodologies in order to yield more sales.

Also, as the Internet has grown, so has the number of advertisements forwarded to users for their consideration. This because there are an enormous number of vendors that wish to present their merchandise to individuals tailored to the specific desires of these individuals. Therefore, some mechanism or service is needed to reduce the number of advertisements presented to users without sacrificing the quality nor advertising range of the E-commerce options available to them. This invention will take personalized advertising one step further and overcome the shortcomings found in the prior art.

To understand another related problem we need to investigate the structure of an advertising message. Typically this message contains product or service information, information where to obtain the product or service, along with some positive reinforcement to act soon and quickly. Looking at an example using advertising for some electronic device:

“The newest Top Brand Refrigerator delivers unmatched performance, for only a small price. Don't hesitate and come by to convince yourself about the unbelievable savings. We are located at 750 Westminster Drive, San Jose. Or call now 1-800-787-0815”

These are the structured elements:

Product Information (“. . . Refrigerator . . . ”);

Motivation (“. . . unbelievable savings . . .”)

Reinforcement for acting (“. . . come by . . . or call now . . . ”)

Location (“. . . 750 Westminster Drive . . . ”)

Currently the advertising message will provide an absolute address. This is because the creators of the advertising need to address a large group of people simultaneously. However, it is difficult for a customer to arrive at that location without some means of directing himself or herself to the sales location. Therefore, there is a need for a means for a user to direct himself or herself to a location displayed in an E-Advertisement.

Finally, Global Positioning System (GPS) receivers normally determine their position by computing relative times of arrival of signals transmitted simultaneously from a multiplicity of GPS (or NAVSTAR) satellites. These satellites transmit, as part of their message, both satellite positioning data as well as data on clock timing, so called “ephemeris” data. The GPS location process comprises the searching for and acquiring of GPS signals, reading the ephemeris data for a multiplicity of satellites and computing the location of the receiver from this data. There are two principal functions of GPS receiving systems: (1) computation of the pseudo-ranges to the various GPS satellites, and (2) computation of the position of the receiving platform using these pseudo-ranges, satellite timing and ephemeris data. The pseudo-ranges are simply the time delays measured between the received signal from each satellite and a local clock. The satellite ephemeris and timing data is extracted from the GPS signal once it is acquired and tracked.

### SUMMARY OF THE INVENTION

Global Positioning System (GPS), Personal Data Assistant (PDA), and wireless communications are combines in order to create a more personalized advertising experience. The invention creates and presents advertising content founded on individual user profiles integrated with the physical geographic location of a consumer. The invention solves the problem of advertising tailored so that it is appropriate to both the user and their current location by including a customer's profile and his/her current location into the advertising message. Also, the invention integrates location tracking, e.g. GPS technology, with a personal electronic calendaring system. Further, an advertising message is more personalized by using a relative address/directions that start from the current customer's location. This information could be provided in the form of driving directions, using the current physical position of the user as a start address.

The location tracking component determines where the customer is at any given moment. This location information is used to create advertising for products or services which are in close proximity to the customer's current location. For example, while traveling down the highway late at night, a user is alerted to things ahead that match the user's profile. If there is a motel coming up the system displays an ad from the motel including its location, special room rates and more. A personal electronic calendaring system (such as “Tempus Fugit”, see http://time.almaden.ibm.com) is used to retrieve the customer's profile information. This profile comprises information about which products or services a customer is interested in, what he or she is looking for, what he or she is doing right now and what he or she is going to do. This information is either obtained from calendar entries or stored in the profile setup of the calendaring system. This collection of information allows for the creation of personalized advertising which depends on customer's interests. For example, a computer shop knows that a particular customer is interested in buying scanner hardware. The computer shop then sends a personalized advertising message about scanner(s) technology to this customer based on the customer's profile and location.

In one embodiment, highly personalized advertising content is delivered to customers using their digital cellular phones, Personal Data Assistants (PDAs), car computer systems or other personal communications devices. Initially, users must setup their profile once in such a system by using a web based calendaring system which has become more and more popular in recent years. In addition the Integration of the GPS technology with a convenient and easy to use calendaring system allows the location information to be easily determined. There are several advantages to the practical application of this invention for advertising businesses and for their customers. First, personalized advertising effectively and efficiently presents targeted advertising to users that are likely to purchase products and services; this thereby dramatically improves sales. Consequently, businesses that make use of the invention make more profit. Second, the more personalized the advertising becomes, the more customers eventually regard this service not as an intrusive extra but rather as a helpful necessity.

In another embodiment, individuals subscribe to a “personalized” advertising channel. For example, as he or she is driving his or her vehicle down a street the service can provide information on this channel. A customer can receive information on products that a) match their desire, and b) are nearby.

In another embodiment, an advertising message is more personalized by using a relative address/directions that start from the current customer's location. This information could be provided in the form of driving directions, using the current physical position of the user as a start address. More generally, much depends on the context and the physical location of the user to determine what type of directions are desired. For example, someone who is already in a store might need directions to find the product on the shelves whilst someone in their vehicle needs a mapping navigational aid to arrive at the store. The advantage of this invention is that it can create advertising content that matches the current goals of a specific person and gives them directions which describe how to travel from their current location to the location of an organization that can help them obtain their goal. For instance, a person traveling late at night in an unfamiliar area may wish to find a nearby motel to spend the night. This invention would generate and present advertising for motels near the person and along their current projected path (i.e. further down the highway). This advertising would include driving directions and estimated times computed from their current location and direction of travel. In addition, the invention can also provide directions within a large building (e.g. a shopping mall), or within a store (direction to the desired product, which aisle or shelf the product or service is in or the equivalent).

Further, in this embodiment the invention personalizes the location element of an advertising message by providing a relative path starting from the current physical location of the user. The system includes a two-way automated communication conducted between the customer and the advertiser. Essentially the invention on the customer's side (information processing unit) communicates with the advertiser or merchant's (hub processing unit) side of the invention. Location information is exchanged, driving directions are calculated and integrated as an element to replace a standard absolute address element with a relative one. Using this invention has several advantages for advertising businesses and for their customers. It is clear that personalized relative address information, since it is based on the current physical location of the customer is very convenient for the customer. Moreover, it could be the key factor in making a purchasing decision; for example, a personalized advertising message could stimulate interest in a product or service that otherwise might have been overlooked. For the advertising company this could result in missed opportunities and lower profits. The advantages for advertising companies are mainly that a highly personalized and customized advertising message is more successful. Also, in-store directions make shopping more efficacious and help to prevent customer frustration thereby motivating them to come back often.

### BRIEF DESCRIPTION OF THE FIGURES

The subject matter which is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a system level overview of a typical information processing network within which the present invention may be practiced.

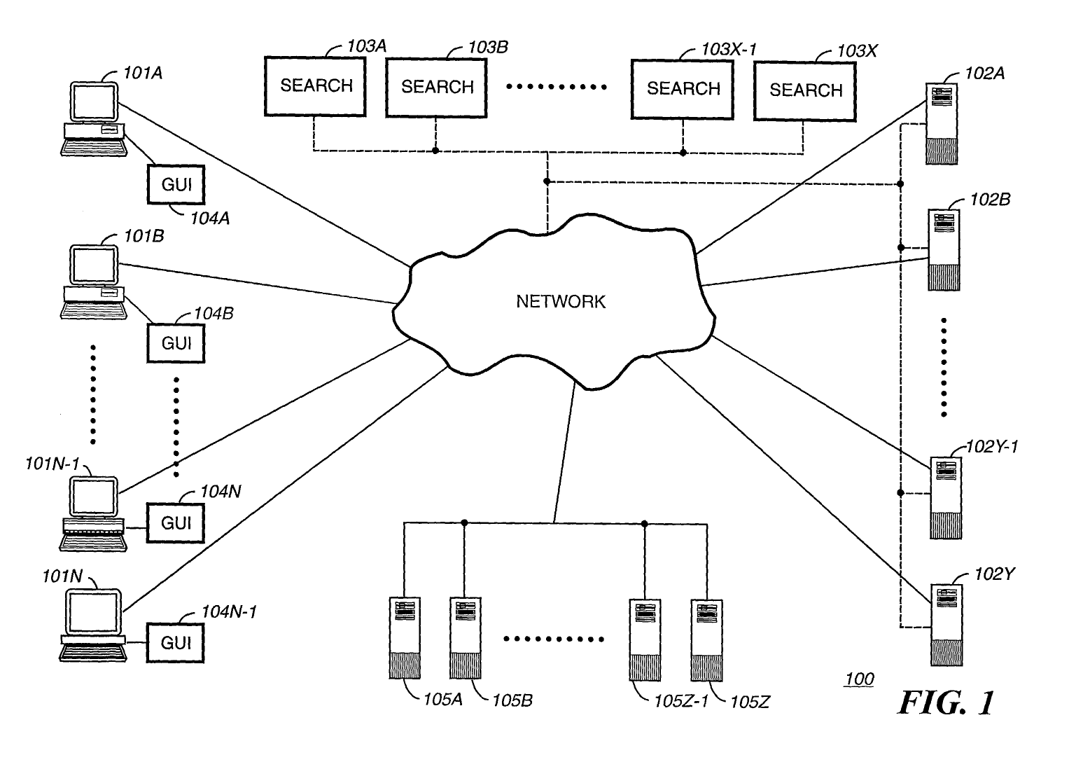

FIG. 2 is a block diagram that illustrates a System Architecture for a Personal Profile Based Advertising System.

FIG. 3 is a flow diagram that illustrates an Initialization Process for the Personalized Advertising System.

FIG. 4 is a flow diagram that illustrates the Interaction between a Control Server and a Merchant Client.

FIG. 5 is a flow diagram that illustrates a generation of Personal Advertising from a Merchant Client.

FIG. 6 is a flow diagram that illustrates a System Architecture for Dynamic Generation of Advertising Messages with Customized Content.

FIG. 7 is a flow diagram that illustrates Personal Advertising with Insertion of Driving Directions.

### DETAILED DESCRIPTION OF THE PREFERRED EMBODIMENTS

It is important to note that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality.

In the drawing like numerals refer to like parts through several views.

Exemplary Embodiment-Personalized Profile Based Advertising System and Method with Integration of Physical Location Using GPS

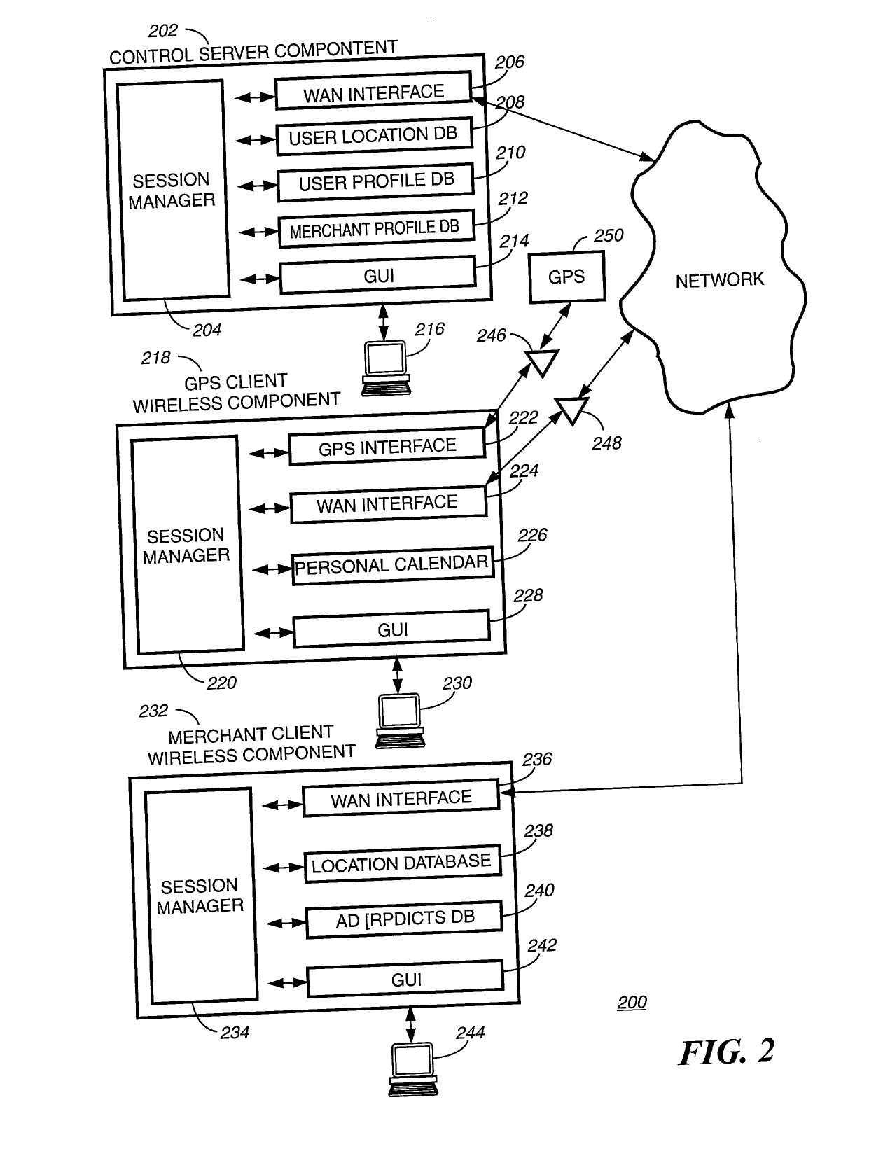

FIG. 2 shows a block diagram (200) of the system. The personalized advertising system includes three main components:

1. Control server component (202);

2. GPS client wireless component (218);

3. Merchant client component (232).

The number in parenthesis refers to the numbers in FIG. 2. Each of these main components comprises the following sub components (see also FIG. 2) shown below:

Control Server Component (202) comprises:

Session Manager (204)

Wide Area Network (WAN) Interface (206)

User Location Database (208)

User Profile Database (210)

Merchant Profile Database (212)

Graphical User Interface (GUI) (214)

Input/Output Device (216)

Global Positioning System (GPS) Client Wireless Component (218) comprises:

Session Manager (220)

GPS Interface (222)

WAN Interface (224)

Personal Calendar (226)

GUI (228)

GPS Antenna (246)

WAN Transceiver Antenna (248)

I/O Device (230)

Merchant Client Component (232) comprises:

Session Manager (234)

WAN Interface (236)

Location Database (238)

Ad Products Database (240)

GUI (242)

I/O Device (244)

GPS (250)

Each of these sections are described below.

Global Positioning System (250)

GPS (250) is the existing GPS satellite system. GPS technology is utilized for location tracking in this invention. Global Positioning System (GPS) receivers normally determine their position by computing relative times of arrival of signals transmitted simultaneously from a multiplicity of GPS (or NAVSTAR) satellites. These satellites transmit, as part of their message, both satellite positioning data as well as data on clock timing, so called “ephemeris” data. The GPS location process comprises the searching for and acquiring of GPS signals, reading the ephemeris data for a multiplicity of satellites and computing the location of the receiver from this data. There are two principal functions of GPS receiving systems: (1) computation of the pseudo-ranges to the various GPS satellites, and (2) computation of the position of the receiving platform using these pseudo-ranges, satellite timing and ephemeris data. The pseudo-ranges are simply the time delays measured between the received signal from each satellite and a local clock. The satellite ephemeris and timing data is extracted from the GPS signal once it is acquired and tracked.

Control Server Component (202)

The control server component (202) a personal computer having a wide area network (WAN) connection (206) for communicating with its client. For connecting into this system, each GPS client wireless component (218) and each Merchant Client Component (MCC 232) has to be registered to the control server component (202) first. The control server component (202) controls and manages the interaction between all of the main components. Control server component (202) comprises the following components: Session Manager (204), WAN interface (206), databases for user location (208), merchant location (212) and user profile (210) as well as a Graphical User Interface (214). Attached to the control server component (202) is an I/O device (216).

Session Manager (204)

The Session Manager (204) is responsible for the communication and interaction between the internal components of the control server component (202). Furthermore, the Session Manager (204) manages the requests of the clients and prepares the incoming and outgoing data to store them to the databases or to send them to the clients.

WAN Interface (206)

The WAN Interface (206) connects the Control Server Component with a network like the Internet. Through this interface the control server component (202) is able to communicate with its clients.

User Location Database (208)

User Location (208) is a database in which the current locations and the last few records of all users are stored. The Locations are stored in latitude and longitude format. The time when the GPS data was received is also stored in this database. The session manager (204) needs at least two records from one user and the time elapsed to measure driving direction and velocity. If requested, the user location is sent by the session manager to the merchant clients (232).

User Profile Database (210)

User Profile (210) is a database in which personal data of users are stored. These data can include a user name, address, interests, IP address or equivalents. The session manager (204) uses this data to establish a connection to the users and to send user's interests to the merchants.

Merchant Profile Database (212)

Merchant Profile (212) is a database in which information of all registered merchants are stored. These records can include a merchant's name, address, IP address, a merchants' location (in latitude/longitude format) or equivalents. The session manager (204) uses the location information to figure out whether one of the users is close to a registered merchant.

Graphical User Interface (GUI) (214)

A graphical user interface (GUI) (214) drives a display (216) and accepts user inputs from a keyboard. Implementation of a GUI facilitates a comfortable and easy access to the system for a system administrator.

I/O Device (216)

The I/O Device (216) may be implemented as a monitor and keyboard. The keyboard is used for manual user inputs and administration. The monitor is for system output and error messages.

GPS Client Wireless Component (218)

The GPS client wireless component (218) may be implemented as a laptop computer, cell phone, personal digital assistant (PDA) or integrated in a vehicular system having a wireless wide area network (WAN) connection (224) for communicating with a server and other clients. The client wireless component (218) includes a GPS interface (222) for receiving location information. A personal electronic calendar system (226) is also integrated in the GPS client wireless component to provide more flexibility. The tasks of this component are first to determined its geographic coordinate is and send this information to the control server component; second, to have access to a user's calendar entries and send them if needed to the control server component (202); and third, to receive personal advertising from merchant client (232) and display it to the user on a display device (230).

Session Manager (220)

The GPS client wireless component (218) operates under the control of the respective Session Manager (220). The session manager (220) is responsible for the interaction between the sub components of the client wireless component (218). It prepares the incoming data, such as location, calendar entries and advertising to forward them either to the control server (202) over the WAN interface (224), display them over the GUI (228) on a screen (230) or store them to the calendar (226).

GPS Interface (222)

The GPS Interface (222) is implemented as a miniaturized GPS receiver that measures the elapsed time between a radio signal leaving a GPS satellite in the GPS system (250) until it arrives at the GPS antenna (246). By knowing the speed of the radio signal (approx. the speed of light) and when each signal is transmitted, the distance to each of the satellites can be determined. The final solution of the predetermined equations produces an exact position of the antenna (246) in latitude and longitude. The GPS receiver interface (222) determines a current location of the GPS client wireless component (218) and supplies the current location to the session manager (220).

WAN Interface (224)

The WAN Interface (224) supports a wireless connection to a network like the Internet. With this interface the GPS client wireless component (218) can always be connected to the server and to other clients.

Personal Electronic Calendar (226)

The Personal Electronic Calendar (226) is an existing calendar system that is integrated in this system. The Personal Electronic Calendar (226) provides the same feature as a usual electronic calendar except now it also includes interfaces for integrating it within the client wireless system.

Graphical User Interface (228)

The graphic user interface (GUI 228) is implemented in the GPS client wireless component (218) to facilitate its configuration and input calendar entries.

GPS Antenna (246)

A GPS Antenna (246) connects to the GPS interface (222) to receive GPS data from the GPS satellite system (250).

WAN Transceiver Antenna (248)

The WAN Transceiver Antenna (248) is for wireless connection to a network like the Internet. The WAN Transceiver Antenna (248) is connected to the WAN interface (224) of the GPS client wireless component (218).

Input Output Device (230)

The Output Device (230) may be implemented as a wireless device display and the Input Device as a touch screen. The touch screen is used for manual user inputs and configuration. The display is for output of possible error messages but primarily for display of advertising content.

Merchant Client Component (232)

The Merchant Client Component (232) may be implemented as a personal computer located and administrated by merchants. Its function is to generate personal advertising depending upon user profiles and locations. The merchant client component (232) includes a WAN interface (236) for connecting to the control server (202) to gather user locations and profiles and to communicate with the user devices (218) GPS clients to send them advertising. This component operates under the control of a session manager (234).

Session Manager (234)

The Session Manager (234) manages the WAN interface (236), the databases (238, 240) where merchants' specific data are stored and the GUI (242). The Session Manager (234) receives all the information it needs from its own components (238, 240, 242) and from the control server (202) to create a user specific advertisement and send this through the WAN interface (236) to the user GPS client components (218).

WAN Interface (236)

The WAN Interface (236) supports the connection to a network like the Internet for the communication and interaction between merchant clients (232), control server (202) and user clients (218).

Location Database (238)

Location database (238) records all the geographical locations of merchants' branches. This information is needed to inform the control server (202) where the merchants are in order to get a message when a user is close to one of the locations.

Advertisement Products Database (240)

The Ad Products database (240) is a collection of advertised merchants' products. The session manager (234) compares the records of this database with the user profile (210) that it requested from the control server (202) to generate personal advertising dependent upon user profile (210). Ad products database (240) is controlled and updated by the merchants.

Graphical User Interface (242)

The graphical user interface (GUI 242) is connected with an I/O Device (244) to display and accept user inputs. They are used for the configuration and updating of the system. For instance, the GUI is utilized to setup the location database (238) and the ad products database (240).

I/O Device (244)

The I/O Device (244) may be implemented as a monitor and keyboard. The keyboard is used for manual user inputs and administration. The monitor is for system output and error messages.

Initialization Process for the Personalized Advertising System

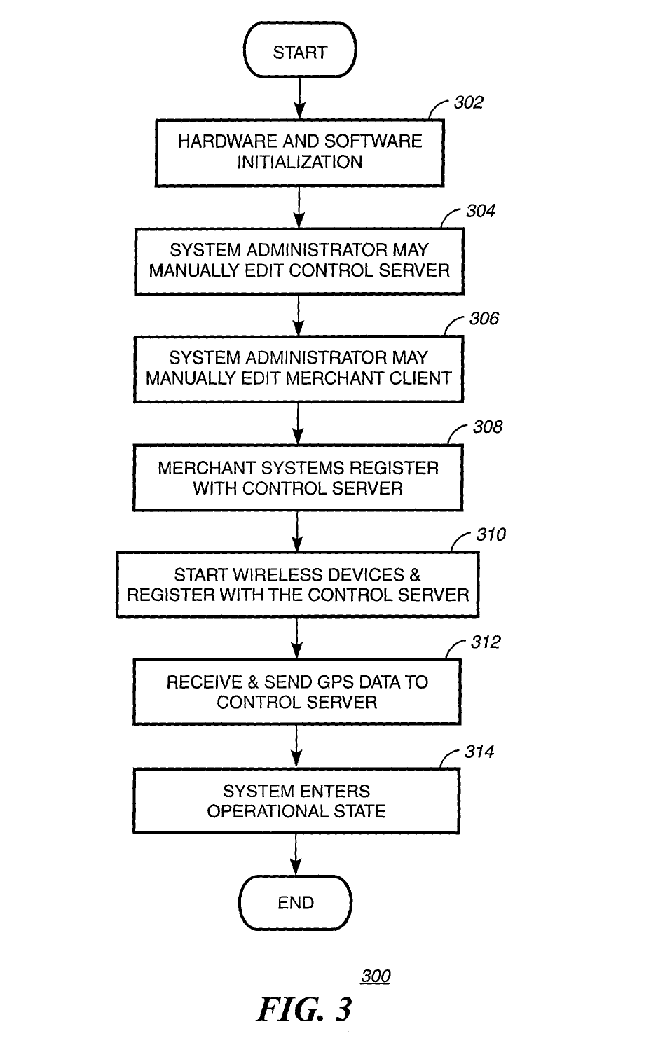

FIG. 3 is a flow diagram of an initialization process for the personalized advertising system. The process starts (302) by performing all necessary hardware and software initialization. Next, (304) the system administrators may manually edit (304) the control server (202) and edit (306) the merchant client (232) by entering inputs into Input/Output devices (216, 244). After completing the editing process the merchant systems (232) connect to the control server (202) by using its WAN interface (236) for registration to the system (308). Then, GPS client wireless components have to start and register themselves to the server as well (310). Reception and forwarding of location data (312) to the server (202) follows. Finally the system enters its operation state (314).

The Interaction Between Control Server Component (202) & Merchant Client Component (232)

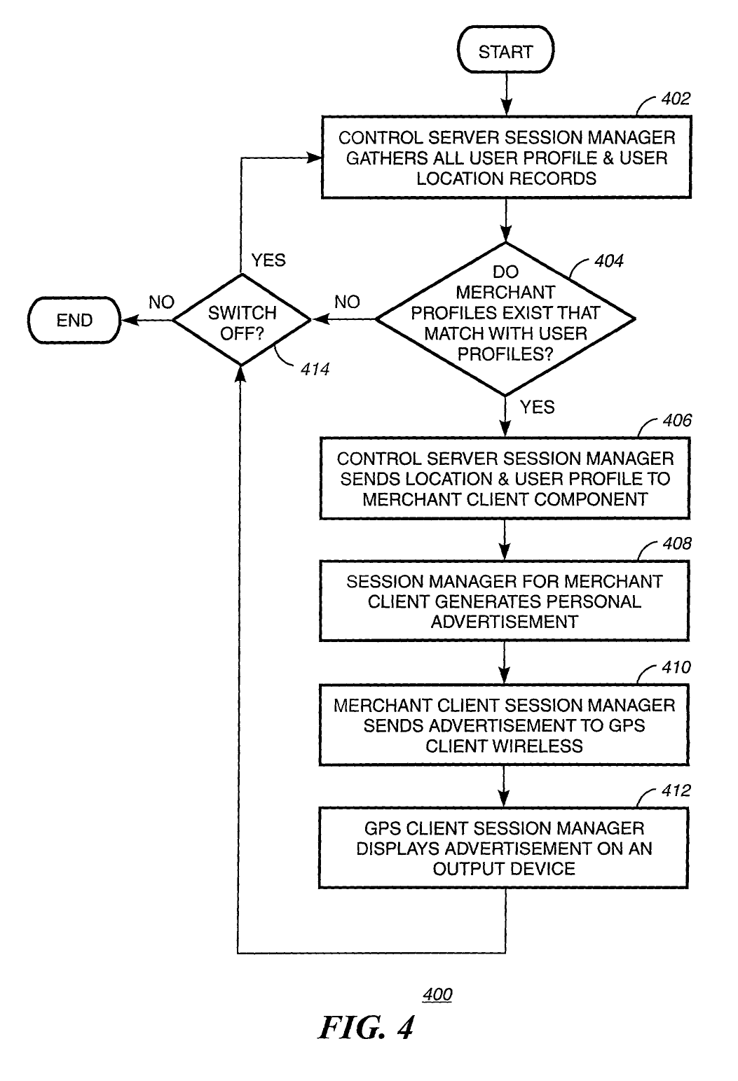

FIG. 4 shows the interaction between the control server component (202) and the merchant client component (232). First, the session manager (204) gathers all records (402) on user profile and user location from the profile (210) and location (208) databases. Then a determination is made for a merchant profile from the merchant profile database (212) that matches with a user profile and location (404). If a match is found, then the session manager (204) transfers the user location and profile (406) to the merchant client component (232). Next, the merchant client session manager (234) generates an advertisement (408) utilizing its ads database (240) and forwards the advertisement (410) to the GPS client wireless component (218) . Finally, the session manager (220) for the GPS client wireless component displays the ad (412) on an output device (230). The process continues indefinitely depending upon whether or not the wireless device is switched off or not.

The Generation of Personal Advertising from a Merchant Client Component (232)

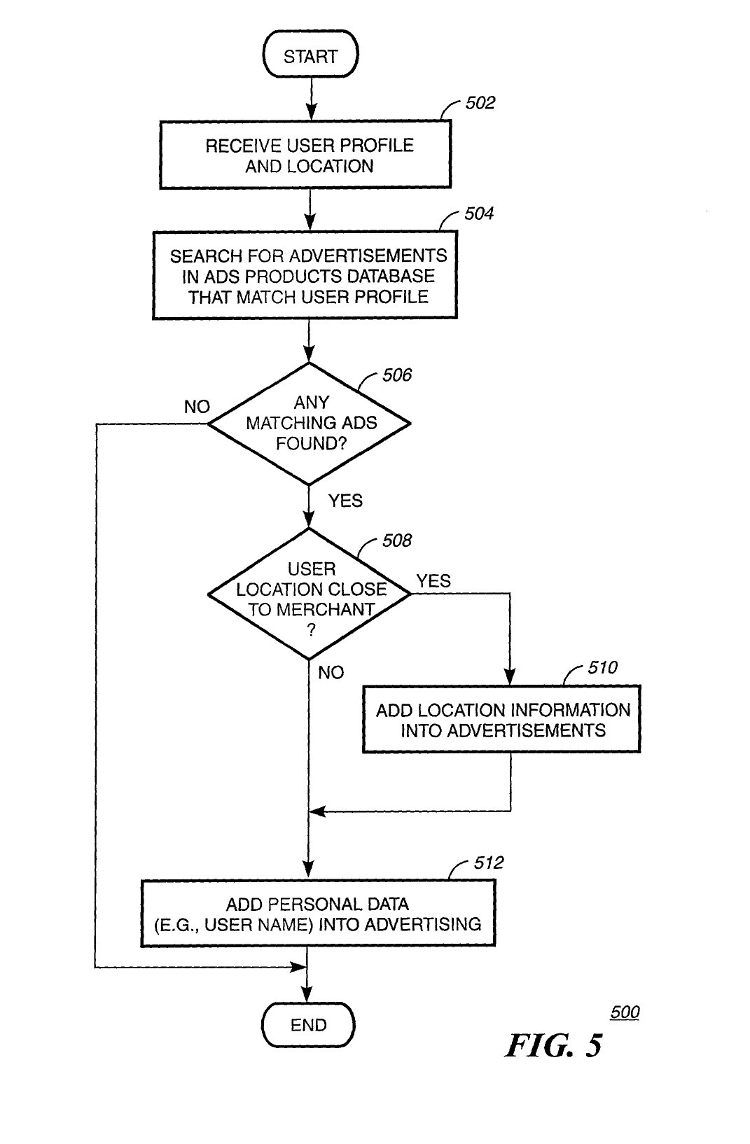

FIG. 5 shows the generation of personal advertising from a merchant client component (232). A user profile and location are received (502) in the merchant client. The session manager (234) performs a search for advertisements (504)in the ads database (240) that match the user profile. A determination is made as to whether or not there exist ads that match the user profile (506). If there are matching ads then a check is performed to determine whether or not the user is in the proximity (508) of the merchant with the matching advertisement; this is accomplished using the location database (238). If a user is close to the merchant's location then location information is added to the advertisement (510) and finally user data is added to the advertisement (512). On the other hand, if no ads match the user profile then the process ends. Also, if a profile is found to match the merchant information yet the user is located far from the merchant then only personalized data is added to the advertisement.

Localized online auction systems such as those available from ebay (www.ebay.com) are widely available in the prior art. Once this invention helps to locate a merchant store using personalized advertising, then a customer is able to make use of the prior art to negotiate a price, for example via an auction style, for a desired item.

Exemplary Embodiment-Dynamically Generated Advertising Messages With Content Customized To Users And Their Physical Location

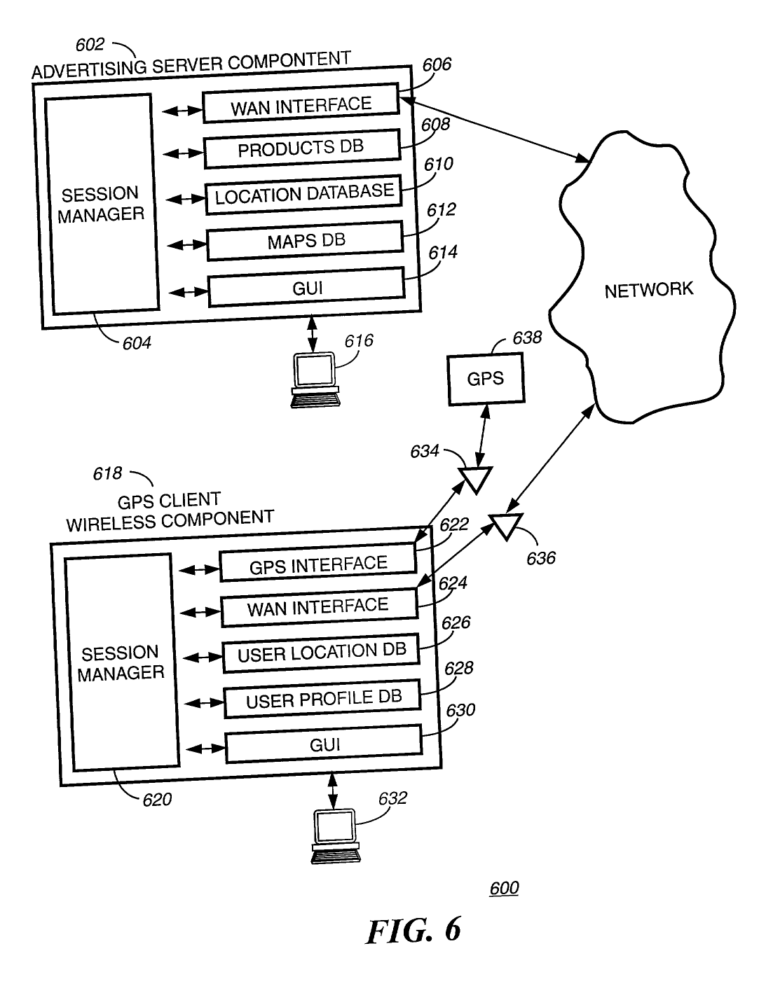

FIG. 6 shows a block diagram of the system. The dynamical advertising system includes two main components:

1. GPS client wireless component (618); and

2. Advertising server component (602).

The number in parenthesis refers to the numbers in FIG. 6.

Each of these main components comprises of the following sub components (see also FIG. 6), shown below:

Global Positioning System (638)

GPS Client Wireless Component (618)

Session Manager (620)

GPS Interface (622)

Wide Area Network Interface WAN (624)

User Location Database (626)

User Profile Database (628)

Graphical User Interface (630)

Global Positioning System (GPS) Antenna (634)

WAN Transceiver Antenna (636)

I/O Device (632)

Advertising Server Component (602)

Session Manager (604)

WAN Interface (606)

Products Database (608)

Location Database (610)

Maps Database (612)

GUI (614)

I/O Device (616)

Each of these sections are described in turn below.

Global Positioning System GPS (638)

GPS (638) is the existing GPS satellite system. Global Positioning System (GPS) receivers normally determine their position by computing relative times of arrival of signals transmitted simultaneously from a multiplicity of GPS (or NAVSTAR) satellites. These satellites transmit, as part of their message, both satellite positioning data as well as data on clock timing, so called “ephemeris” data. The GPS location process comprises the searching for and acquiring of GPS signals, reading the ephemeris data for a multiplicity of satellites and computing the location of the receiver from this data. There are two principal functions of GPS receiving systems: (1) computation of the pseudo-ranges to the various GPS satellites, and (2) computation of the position of the receiving platform using these pseudo-ranges, satellite timing and ephemeris data. The pseudo-ranges are simply the time delays measured between the received signal from each satellite and a local clock. The satellite ephemeris and timing data is extracted from the GPS signal once it is acquired and tracked.

GPS Client Wireless Component (618)

The GPS client wireless component (618) may be implemented as a laptop computer, cell phone, personal digital assistant (PDA) or integrated in a vehicular system, having a wireless wide area network (WAN) connection (624) for communication with an advertising server (602). The client wireless component includes a GPS interface (622) for reception of location information. This component is tasked to determine the current location of the user, and to store this information locally in user location database (626). Secondly, the client wireless component has access to user profiles and forwards these as needed to advertising server component (602). Finally, the client wireless component receives personal advertising from the advertising server component (602), and displays this advertising for the user on a display device (632).

Session Manager (620)

The GPS client wireless component (618) operates under the control of Session Manager (620). This component is responsible for the interaction between the sub-components of the client wireless component. The GPS client wireless component (618) prepares the incoming data, such as location, profile information and advertising to send them either to advertising server component (602) over the WAN interface (624), displays them over the GUI (630) on a screen (632), or stores them to profile or location databases (628,626).

GPS Interface (622)

The GPS Interface (622) is implemented as a miniaturized GPS receiver that measures the elapsed time between a radio signal leaving a GPS satellite in the GPS system (638) until it arrives at the GPS antenna (634). By knowing the speed of the radio signal (approximately the speed of light) and the time the signal is transmitted, the distance to each of the several GPS satellites can be determined. The final solution of the predetermined equations produces an exact position for the antenna (634) in latitude and longitude. The GPS receiver interface determines a current location of the GPS client wireless component (618) and supplies the current location to the session manager (620).

Wide Area Network Interface WAN (624)

The WAN Interface (624) supports a wireless connection to a network like the Internet. With this interface the GPS client wireless component can always be connected to a communication network.

User Location Database (626)

User location database (626) may be implemented as random access memory (RAM) to store a user's current location and the last few location records. The session manager (620) needs at least two records to measure its driving direction. This information isl be sent to an advertising server component (602).

User Profile Database (628)

User profiles contain the user's interest and what he or she is searching for. This information may already exist in other systems, e.g. a calendaring system. The profile information can be implemented as a database or random access memory (RAM).

Graphical User Interface (630)

The graphical user interface (GUI 630) is implemented in a GPS client wireless component (618). The GUI 630 is connected with an I/O Device (632) to display and accept user inputs. These inputs are used for the configuration and updating of the system. For instance, the GUI is utilized to setup the profile database (628)

Global Positioning System (GPS) Antenna (634)

A GPS Antenna (634) connects to the GPS interface (622) to receive GPS data from the GPS satellite system (638).

WAN Transceiver Antenna (636)

The WAN Transceiver Antenna (636) is for the wireless connection to a network like the Internet. The WAN Transceiver Antenna (636) is connected to the WAN interface (624) of the GPS client wireless component (618).

I/O Device (632)

The Output Device (632) may be implemented as a wireless device display and the Input Device (632) as a touch screen. The touch screen is used for manual user inputs and configuration. The display is for output of possible error messages but primarily for display of advertising content.

Advertising Server Component (602)

The Advertising Server Component (602) may be implemented as a personal computer located and administrated by the merchants. Its function is to generate personal advertising depending on a user's profile and current location. The advertising server component includes a WAN interface (606) for communicating with the user devices (618) to get a user's location and profile. In addition, the advertising server component sends advertising including driving directions to the user. This component operates under the control of the session manager (604).

Session Manager (604)

The Session Manager (604) manages the WAN interface (606), the product (608) location (610) and map (612) databases, where merchants' specific data are stored and the GUI (614). The Session Manager (604) gets all necessary information from its own database components, and from user client wireless components (618) to create advertising specific to a user. Then the Session Manager (604) sends this advertising through the WAN interface (606) to the client wireless component (618).

WAN Interface (606)

The WAN Interface (606) supports the connection to a network like the Internet for the communication and interaction between the advertising server component (602) and client wireless components (618).

Products Database (608)

The Products database (608) is a collection of products and their locations. When a client wireless component (618) sends a request with its profile (628) and location (626), the session manager (604) analyzes these records for matches with data stored in the products (608) location (610) and maps (612) databases in order to get the identity of a product and its location, and to formulate driving directions to the product. All of this is forwarded to a client wireless component as advertising. Product database (608) is controlled and updated by merchants.

Location Database (610)

Location (610) is implemented as a database. Its records the geographical locations of merchant's branches. This information is needed to find out which branch a user is close to.

Maps Database (612)

The Maps database (612) stores map information of cities, shopping malls and aisles within stores. This information is needed to generate directions to a given product.

GUI (614)

The graphical user interface (GUI 614) is connected with an I/O Device (616) to display and accept user inputs. They are used for the configuration and updating of the system. For instance, the GUI is utilized to setup the location database (610) and the products database (608).

I/O Device (616)

I/O Device (616) displays and accepts user inputs that are used for configuration and updating of the system. For instance, the I/O device can be used to setup the location databases (610) and the products database (608).

Personal Advertising with Insertion of Driving Directions

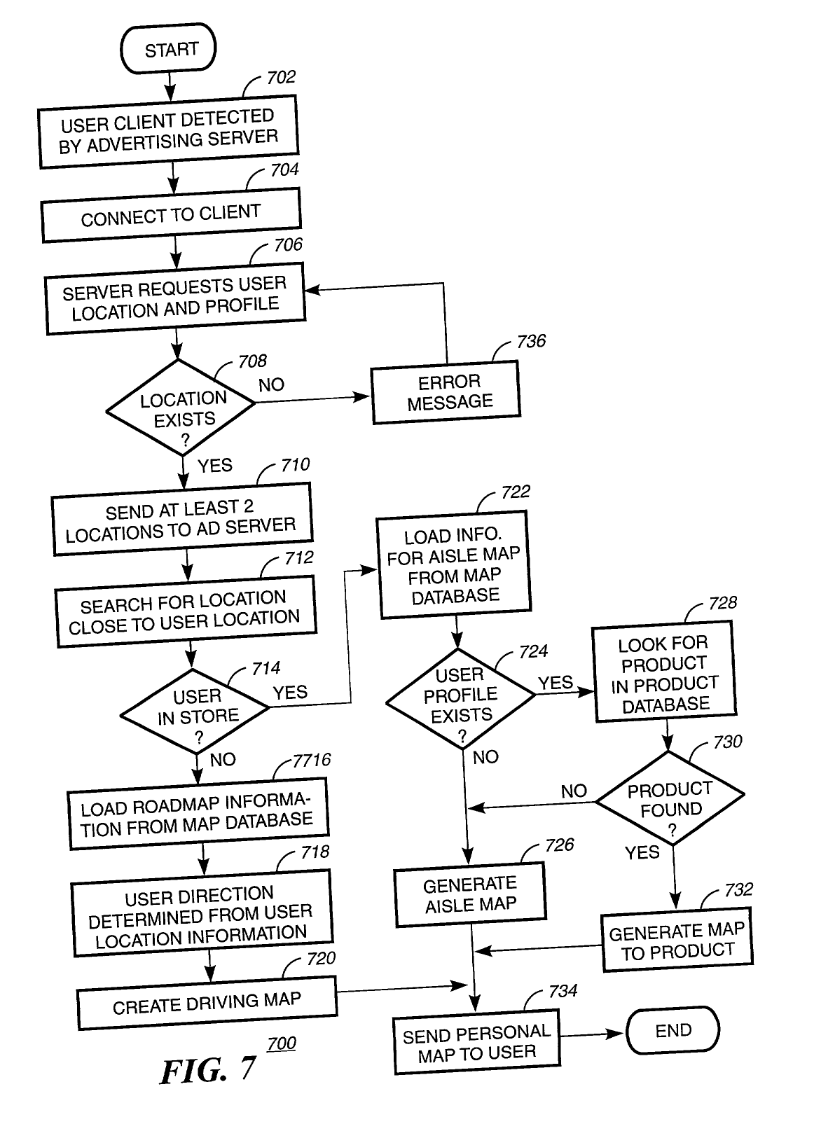

FIG. 7 is a flow diagram demonstrating a functional overview that includes insertion of driving direction into personal advertising. This process starts whenever a user client wireless component (618) is detected (702) by the advertising server (602). The advertising server tries to establish a connection (704) to the client wireless component in order to exchange information. After connecting to the client wireless component, the advertising server (602) requests (706) the user's current location, which is stored in the user location database (626), and the user profile, which is stored in profile database (628). If the location records are not found (708), possibly because the GPS system didn't work, the client wireless component informs the advertising server with an error message (736). The server tries then to request this information again. If location information is available, then the client sends at least two location records (the current and the last one) to the advertising server (710). Then the advertising server searches (712) in its location database (610) for records that match or are close to the user's current location; at least one record must match for an advertisement to be forwarded. With the record of the user's current location and the merchant's location, it is possible for the advertising server to find out whether the user is already in the store or not (714). However, if the user is still proceeding on the highway and has not reached the store yet, then the advertising server needs at least two location records of the user to determine his driving direction and provide him with directions to the store. To accomplish this, roadmap information is loaded into the server (716) from the map database (612). User direction is determined (718) from the two location records of the user previously forwarded to the advertising server (710). After having the user's travel direction, the server creates (720) a driving map from the user's current location including the user's actual direction to the store.

In the event the user is already in the store, he or she does not need any driving directions or maps. In this case the server loads the aisle map information (722) from the map database (612). When a perusal (724) of a user profile indicates that a user does not want a specific product, the advertising server generates a general aisle map (726) for a store. When a perusal of a user profile indicates that a user wants a specific product, the advertising server searches for this product (728) in its products database (608) to find out where the product is located. Then a check is made to determine if the store has or does not have this product (730); if it does not, the server generates a general store map (726); if it does have the product then a personal map from the user's current location to the product in the store is generated (732). Finally, one of the maps previously described above, is sent in digital form (734) to the user's client wireless component (618)

The proposed invention makes use of the GPS system. However, its purpose is to personalize location based information to make use of relative address information, instead of providing a more general absolute address. Once the invention assists a user in locating a store, a system described in the prior art to negotiate a price (auction style) for a desired item can be used.

Thus, a system and method for personalized profile based advertising has been described which overcomes the deficiencies of the prior art by integration of physical location using GPS and dynamic generation of advertising messages with content customized both to users and their physical location.

Discussion of Hardware and Software Implementation Options

The present invention, as would be known to one of ordinary skill in the art could be produced in hardware or software, or in a combination of hardware and software. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in art.

According to the inventive principles as disclosed in connection with the preferred embodiment, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer, as would be known to one of ordinary skill in the art. The computer medium which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, Flash memory, floppy disk, Disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, that allow a computer to read such computer readable information.

What is claimed is:

1. A method for personalized profile based advertising associated with a network of hub processing units coupled to a plurality of information processing units over a network, the method of personalized profile based advertising on a first hub processing unit comprising the steps of:
entering an initializing routine to initialize hardware and software of the first hub processing unit by performing the sub-steps of:
an administrative receiving step of receiving administrative commands from a user to edit software on the first hub processing unit;
a registration step of receiving registration information from a second hub processing unit and from information processing units associated with the network;
a profile receiving step of receiving profile data and location data about locations of the information processing units;
entering an operational state for the personalized profile based advertising and performing the sub-step of:
gathering by a first manager associated with the first hub processing unit a received location data as well as a user profile data associated with an information processing unit stored in a database associated with the first hub processing unit.

2. The method as defined in claim 1, wherein the registration sub-step of receiving registration information from a second hub processing unit and from information processing units associated with the network further comprises the registration information from the second hub processing unit comprises registration information that has been modified by a user.

3. The method as defined in claim 1, wherein the registration sub-step of receiving registration information from a second hub processing unit and from information processing units associated with the network further comprises receiving registration information from a second hub processing unit wherein the second hub processing unit is an initialized hub processing unit.

4. The method as defined in claim 1, wherein the registration sub-step of receiving registration information from a second hub processing unit and from information processing units associated with the network further comprises the second hub processing unit being a merchant server.

5. The method as defined in claim 1, wherein the registration sub-step of receiving registration information from a second hub processing unit and from information processing units associated with the network further comprises the information processing units comprising wireless components.

6. The method as defined in claim 1, wherein the registration sub-step of receiving registration information from a second hub processing unit and from information processing units associated with the network further comprises the information processing units being initialized information processing units.

7. The method as defined in claim 1, wherein the information processing units comprise information processing units selected from the group of information processing units consisting of cellular phones, personal data assistants, car computer systems and personal communication devices.

8. The method as defined in claim 1, wherein the step of entering an operational state for the personalized profile based advertising further comprises performing after the gathering sub-step the further sub-steps of:
determining whether or not the user profile matches a merchant profile and if the user profile matches a merchant profile matches then performing the secondary sub-steps of:
forwarding the user location and profile to the second hub processing unit which performs further processing; and
checking whether or not the information processing unit is turned on and if the information processing unit is turned on then continuing the personalized advertising process and if the information processing unit is not turned on then, ending the process for the information processing unit;
wherein, if the user profile does not match the merchant profile then performing the secondary sub-step of:
checking whether or not the information processing unit is turned on and if the information processing unit is turned on then continuing the personalized advertising process; otherwise, ending the process for the information processing unit.

9. A method for personalized profile based advertising associated with a network of hub processing units coupled to a plurality of information processing units over a network, the method of personalized profile based advertising on a second hub processing unit comprising the steps of:
receiving location data and user profile data about an information processing unit from a first hub processing unit;
generating a personalized advertisement based upon the received location data as well as a user profile data associated with the information processing unit; and
forwarding the personalized advertisement to the information processing unit for display on an output device.

10. The method as defined in claim 9, wherein the information processing units comprise information processing units selected from the group of information processing units consisting of cellular phones, personal data assistants, car computer systems, wireless systems and personal communication devices.

11. The method as defined in claim 9,wherein the second hub processing unit comprises the second hub processing unit being a merchant server.

12. The method as defined in claim 9, wherein the step of generating a personal advertisement further comprises the sub-steps of:
searching for advertisements in a database associated with the second hub processing unit for any ad profiles that match a user profile and if there are ads that match then performing the secondary sub-steps of:
determining whether or not a user location is close to a sales location and if user location is close to a sales location then performing the tertiary sub-steps of:
adding location information into the advertisement;
adding personal data into the advertisement; and
terminating the generating of personal advertising step;
wherein if the user location and sales location are not if user location is close to a sales location then performing the tertiary sub-steps of:
adding personal data into the advertisement; and
terminating the generating of personal advertising step;
wherein if there are no advertisements that match a user profile then terminating the generating of personal advertising step.

13. The method as defined in claim 12, wherein the adding of personal data tertiary sub-steps further comprise adding personal data selected from the group of persnal data consisting of a name, interests, age, background, education, hobbies and other personalized data relating to the user.

14. A method for personalized profile based advertising associated with a network of hub processing units coupled to a plurality of information processing units over a network, the method of personalized profile based advertising on a first hub processing unit comprising the steps of:
detecting an active information processing unit;
connecting to the active information processing unit;
requesting user location records and profile from the active information processing unit and if the location records exist then performing the sub-steps of:
receiving active information processing unit location records;
searching for sales locations close to the user location records;
determining if the user location records indicate if a user is in a sales location and if the user is in a sales location then performing the sub-steps of:
loading map information from a first map database;
determining if a user profile exists and if a user profile exists then performing the sub-steps of:
searching for a product in a products database;
determining if any product matches the user profile; and if a product matches the user profile then performing the sub-steps of:
generating a first map;
sending the first map to the active information processing unit;
wherein if no product matches the user profile then performing the sub-steps of:
generating a second map;
sending the second map to the active information processing unit;
wherein if a user profile does not exist then performing the sub-steps of:
generating a third map;
sending the third map to the active information processing unit;
wherein if the user location records indicate that a user is not in a sales location then performing the sub-steps of:
loading map information from a second map database;
determining user direction from the user location records; creating a fourth map;
sending the fourth map to the active information processing unit;
wherein if the user location records do not exist then performing the sub-steps of:
receiving an error message from the active information processing unit.

15. The method as defined in claim 14, wherein the first hub processing unit comprises an advertisement server.

16. The method as defined in claim 14, wherein the information processing units comprise information processing units selected from the group of information processing units consisting of cellular phones, personal data assistants, car computer systems and personal communication devices.

17. The method as defined in claim 14, wherein the active information processing unit records comprise at least two location records for the active information processing unit.

18. The method as defined in claim 14, wherein the first map comprises a map to the matched product, the second map and third maps comprise generic aisle maps for the sales location, and the fourth map comprises a driving map from a user location to a sales location.

19. The method as defined in claim 14, wherein the first map database comprises sales location aisle map information and the second map database comprises road map information.

20. An information processing unit apparatus for personalized profile based advertising associated with a network of hub processing units coupled to a plurality of information processing units over a network, the information processing unit apparatus comprising:
a manager for directing and coordinating the operation of the following components:
a location interface component for receiving location signals from a global positioning system (GPS);
a communication interface for communicating via a network with hub processing units selected unit consisting of a control server a merchant server, and an advertising server;
an output for one or more databases for storage of personal information;
an output for graphical user interface for displaying information and receiving user inputs; and
an input output for effecting the display of the graphical user interface and for effecting the input of user commands.

21. A merchant advertising hub processing unit apparatus for personalized profile based advertising associated with a network of hub processing units coupled to a plurality of information processing units over a network, the merchant advertising hub processing unit apparatus comprising:
a manager for directing and coordinating the operation of the following components:
a communication interface for communicating via a network with devices selected from the group of groups: a control server hub processing unit with information processing units and information processing units;
a group of databases for storage of information selected from the group of groups: locations database with advertisement information database and locations database with products database also with maps information database;
a graphical user interface for displaying information and receiving user inputs; and
an input output device for effecting the display of the graphical user interface and for effecting the input of user commands.

22. A control hub processing unit apparatus for personalized profile based advertising associated with a network of hub processing units coupled to a plurality of information processing units over a network, the control hub processing unit apparatus comprising:
a manager for directing and coordinating the operation of the following components:
a communication interface for communicating via a network with merchant hub processing units and with information processing units;
a group of databases for storage of information including user locations, user profiles and merchant profiles;
a graphical user interface for displaying information and receiving user inputs; and
an input output device for effecting the display of the graphical user interface and for effecting the input of user commands.
